(19) United States
(12) Patent Application Publication
(10) Pub. No.: US 2026/0340916 A1
(43) Pub. Date: Oct. 29, 2026

(54) VIRTUAL OBJECT RENDERING METHOD AND APPARATUS, AND DEVICE AND STORAGE MEDIUM

(71) Applicant: Beijing Zitiao Network Technology Co., Ltd., Beijing (CN)

(72) Inventors: Xin CAI, Beijing (CN); Jiacheng LIU, Beijing (CN)

(21) Appl. No.: 19/116,980

(22) PCT Filed: Sep. 21, 2023
(86) PCT No.: PCT/CN2023/120222

§ 371 Date: Mar. 28, 2025

(30) Foreign Application Priority Data
Sep. 29, 2022 (CN) 202211204095.X

(51) Int. Cl. G06T 13/20; G06T 7/73; G06T 15/20; G06T 19/20

(52) U.S. Cl. CPC G06T 13/20; G06T 7/75; G06T 15/205; G06T 19/20; G06T 2207/10024; G06T 2207/20221; G06T 2207/30196; G06T 2210/16; G06T 2219/2012

(57) ABSTRACT

Embodiments of the present disclosure provide a method and apparatus, and a device and a storage medium for virtual object rendering. The method includes obtaining skeleton point position information of a target object in a current image and initial position information of a plurality of vertexes of a virtual object; transforming the initial position information of the plurality of vertexes based on the skeleton point position information to obtain intermediate position information of the plurality of vertexes; updating the intermediate position information of at least some of the plurality of vertexes of the virtual object based on set material information to obtain target position information; and rendering the virtual object based on the target position information to obtain a target image.

This application claims priority to Chinese Patent Application No. 202211204095.X, filed with the China National Intellectual Property Administration on Sep. 29, 2022, the disclosure of which is incorporated herein by reference in its entirety.

### FIELD

Embodiments of the present disclosure relate to the technical field of augmented reality, and for example, to a method and apparatus, and a device and a storage medium for virtual object rendering.

### BACKGROUND

With the continuous development of Augmented Reality (AR) technology, generation of virtual objects in a real scenario through the AR technology has been widely applied. Trying on clothing for users is an application scenario in the AR technology. In the related technology, the clothing tried on cannot fit well with the movements of characters, and lacks the dynamic effect and texture of real clothing, so that the fitting effect is poor.

### SUMMARY

The embodiments of the present disclosure provide a method and apparatus, and a device and a storage medium for virtual object rendering, so that a virtual object that is tried on can fit well with motions of a target object, and the virtual object may have the dynamic effect and texture of a real object, which enhances the rendering effect.

In a first aspect, the embodiments of the present disclosure provide a method for virtual object rendering, including:
obtaining skeleton point position information of a target object in a current image and initial position information of a plurality of vertexes of a virtual object, wherein the plurality of vertexes of the virtual object are a plurality of vertexes of a 3 Dimensional (3D) model corresponding to the virtual object;
transforming the initial position information of the plurality of vertexes based on the skeleton point position information to obtain intermediate position information of the plurality of vertexes;
updating the intermediate position information of at least some of the plurality of vertexes of the virtual object based on set material information to obtain target position information; and
rendering the virtual object based on the target position information to obtain a target image, wherein the target object in the target image wears the virtual object.

In a second aspect, the embodiments of the present disclosure provide an apparatus for virtual object rendering, including:
an obtaining module, configured to obtain skeleton point position information of a target object in a current image and initial position information of a plurality of vertexes of a virtual object, wherein the plurality of vertexes of the virtual object are a plurality of vertexes of a 3D model corresponding to the virtual object;
a position information transformation module, configured to transform the initial position information of the plurality of vertexes based on the skeleton point position information to obtain intermediate position information of the plurality of vertexes;
a target position information obtaining module, configured to update the intermediate position information of at least some of the plurality of vertexes of the virtual object based on set material information to obtain target position information; and
a rendering module, configured to render the virtual object based on the target position information to obtain a target image, wherein the target object in the target image wears the virtual object.

In a third aspect, the embodiments of the present disclosure provide an electronic device. The electronic device includes:
one or more processors; and
a storage apparatus, configured to store one or more programs,
wherein the one or more programs, when executed by the one or more processors, cause the one or more processors to perform the method for virtual object rendering described in the embodiments of the present disclosure.

In a fourth aspect, the embodiments of the present disclosure further provide a storage medium including computer-executable instructions. When executed by a computer processor, causing the computer processor to perform the method for virtual object rendering described in the embodiments of the present disclosure.

### BRIEF DESCRIPTION OF THE DRAWINGS

Throughout the accompanying drawings, identical or similar reference numerals represent identical or similar elements. It should be understood that the accompanying drawings are illustrative, and components and elements may not necessarily be drawn to scale.

FIG. 1 is a flowchart of a method for virtual object rendering according to an embodiment of the present disclosure;

FIG. 2 is a schematic diagram of a rendered virtual object according to an embodiment of the present disclosure;

FIG. 3 is an example diagram of a color noise image according to an embodiment of the present disclosure;

FIG. 4a is an example diagram of a target object sampling image according to an embodiment of the present disclosure;

FIG. 4b is an example diagram of a first mask image according to an embodiment of the present disclosure;

FIG. 4c is an example diagram of a virtual object according to an embodiment of the present disclosure;

FIG. 4d is an example diagram of a target image according to an embodiment of the present disclosure;

FIG. 5a is an example diagram of displaying of a virtual object according to an embodiment of the present disclosure;

FIG. 5b is an example diagram of displaying of another virtual object according to an embodiment of the present disclosure;

FIG. 6 is an example diagram of an apparatus for virtual object rendering according to an embodiment of the present disclosure; and

FIG. 7 is a schematic structural diagram of an electronic device provided according to an embodiment of the present disclosure.

### DETAILED DESCRIPTION OF EMBODIMENTS

The embodiments of the present disclosure will be described below with reference to the accompanying drawings. Although the accompanying drawings show some embodiments of the present disclosure, it should be understood that the present disclosure can be implemented in various forms, and should not be explained as being limited to the embodiments stated herein. Rather, these embodiments are provided for understanding the present disclosure more thoroughly and completely. It should be understood that the accompanying drawings and embodiments of the present disclosure are only used for illustration, but are not intended to limit the protection scope of the present disclosure.

It should be understood that multiple steps recorded in method implementations of the present disclosure can be executed in different orders and/or in parallel. In addition, the method implementations may include additional steps and/or omit the execution of the steps shown. The scope of the present disclosure is not limited in this aspect.

The term “include” and its variants as used herein mean widespread inclusion, namely, “including but not limited to”. The term “based on” is “based at least in part on”. The term “one embodiment” means “at least one embodiment”. The term “another embodiment” means “at least another embodiment”. The term “some embodiments” means “at least some embodiments”. Relevant definitions of other terms will be given in the description below.

The concepts such as “first” and “second” mentioned in the present disclosure are only used to distinguish different apparatuses, modules, or units, and are not intended to limit the order or interdependence of the functions performed by these apparatuses, modules, or units.

The modifications of “one” and “plurality” mentioned in the present disclosure are indicative rather than restrictive, and those skilled in the art should understand that unless otherwise clearly stated in the context, they should be understood as “one or more”.

Messages or names of information interacted between a plurality of apparatuses in the implementations of the present disclosure are only for illustrative purposes and are not intended to limit the messages or the scope of the information.

Before use of the technical solutions disclosed in the plurality of embodiments of the present disclosure, users should be informed of the type, scope of use, usage scenarios, and the like of personal information involved in the present disclosure in accordance with relevant laws and regulations in an appropriate manner, so as to obtain authorization from the users.

For example, in response to that an active request of a user has been received, prompt information is sent to the user to clearly remind the user that personal information of the user needs to be involved in an operation requested to be executed. Thus, the user can independently select whether to provide the personal information to software or hardware such as an electronic device, an application program, a server, or a storage medium that performs the operation of the technical solutions of the present disclosure according to the prompt information.

As an optional but non-restrictive implementation, in response to that an active request of a user has been received, prompt information is sent to the user through, for example, a pop-up window where the prompt information can be presented in text. In addition, the pop-up window can also carry a selection control for the user to select whether to “agree” or “refuse” to provide the personal information to the electronic device.

The above notification and the above user authorization obtaining process are only illustrative and do not constitute a limitation on the implementations of the present disclosure. Other methods that meet the relevant laws and regulations can also be applied to the implementations of the present disclosure.

Data involved in the technical solutions (including but not limited to the data itself, and obtaining or use of the data) should comply with the requirements of corresponding laws and regulations and relevant provisions.

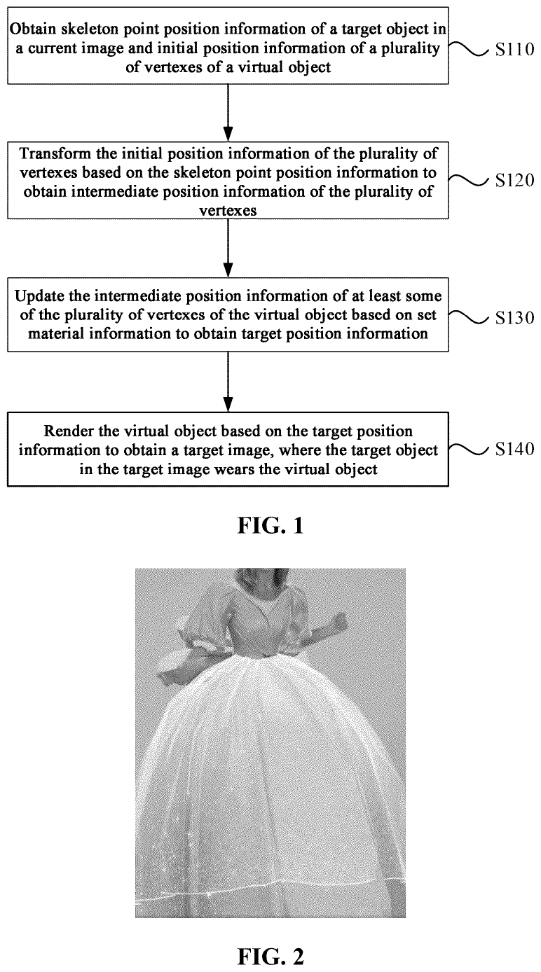

FIG. 1 is a flowchart of a method for virtual object rendering according to an embodiment of the present disclosure. This embodiment of the present disclosure is applicable to a situation for rendering a virtual object. The method may be performed by an apparatus for virtual object rendering. The apparatus can be implemented in the form of software and/or hardware. Alternatively, the apparatus is implemented through an electronic device. The electronic device can be a mobile terminal, a personal computer (PC) end, a server, or the like.

As shown in FIG. 1, the method includes:
S110. Skeleton point position information of a target object in a current image and initial position information of a plurality of vertexes of a virtual object are obtained.

The current image may be a static image, a real-time acquired image, or a frame of image in a video. The target object may be a person or an animal. In this application scenario, the target object is a person. The virtual object may be pre-built 3D virtual object, such as virtual clothing or a virtual ornament. The plurality of vertexes of the virtual object may the plurality of vertexes of a 3D model corresponding to the virtual object. The initial position information of the plurality of vertexes of the virtual object may be understood as three-dimensional coordinates of the plurality of vertexes of the virtual object in a world coordinate system.

The skeleton point position information may be three-dimensional coordinates of key skeleton points in the world coordinate system. In this embodiment, a mode for obtaining the skeleton point position information of the target object in the current image may be: performing key skeleton point detection or pose detection on the target object in the current image, thereby obtaining position information of a plurality of key skeleton points. A pose detection algorithm or a key skeleton point detection algorithm may be used to obtain the skeleton point position information, without limitation here.
S120. The initial position information of the plurality of vertexes are transformed based on the skeleton point position information to obtain intermediate position information of the plurality of vertexes.

In this embodiment, the virtual object will move as the target object moves. Namely, the position information of the plurality of vertexes of the virtual object changes as the skeleton point position information changes.

A mode for transforming the initial position information based on the skeleton point position information may be: for each of the plurality of vertexes of the virtual object, obtaining a plurality of skeleton points associated with the vertex of the virtual object and position impact weights of the plurality of skeleton points on the vertex of the virtual object; determining vertex transformation information of the vertex based on position information of the plurality of skeleton points and the position impact weights; and transforming the initial position information of the vertex based on the vertex transformation information of each vertex to obtain the intermediate position information of the vertex.

The position impact weight may be understood as an impact degree of the positions of the skeleton points on the position of the vertex of the virtual object. The position impact weight is related to a distance between the skeleton points and the vertex of the virtual object. If the skeleton points are closer to the vertex of the virtual object, the position impact weight of the skeleton points on the vertex of the virtual object is larger. If the skeleton points are farther from the vertex of the virtual object, the position impact weight of the skeleton points on the vertex of the virtual object is smaller, thereby achieving an effect that the virtual object moves as a human body moves. Exemplarily, for a vertex of the virtual object close to knee skeleton points, the vertex is greatly affected by the knee skeleton points. When the human body bends the knees, the vertex of the virtual object close to the knee skeleton points will undergo significant position changes with the movement of the knee skeleton point.

In this embodiment, the process of obtaining a plurality of skeleton points associated with the vertex of the virtual object and position impact weights of the plurality of skeleton points on the vertex of the virtual object may be: first, binding the virtual object to the skeleton points of the target object, and determining the plurality of skeleton points associated with each vertex of the virtual object and obtaining the position impact weights of the plurality of skeleton points on the vertex of the virtual object. In this application scenario, each vertex of the virtual object is associated with four skeleton points. A mode for determining vertex transformation information of the vertex based on the position impact weights and position information of the plurality of skeleton points: performing weighted summation on the position information of the plurality of skeleton points based on the position impact weights to obtain the vertex transformation information of the vertex.

The vertex transformation information can be represented by a matrix. A mode for transforming the initial position information of the vertex based on the vertex transformation information of the vertex may be: performing point multiplication on the matrix corresponding to the vertex transformation information of the vertex by a vector corresponding to the initial position information of the vertex, thereby obtaining a vector corresponding to the intermediate position information of the vertex. In this embodiment, the initial position information is transformed based on the vertex transformation information, so that the virtual object moves as the target object moves, thereby enhancing the realistic effect of wearing the virtual object on the target object.
S130. The intermediate position information of at least some of the plurality of vertexes of the virtual object is updated based on set material information to obtain target position information.

The set material information may be characterized based on material parameters, and different material parameters correspond to different materials. In this embodiment, a set material may be a cloth material. Firstly, the plurality of vertexes of the virtual object are divided into at least two portions based on the mapping coordinates of the vertexes. Then, the vertexes of one or more portions are selected from the at least two portions, so that the intermediate position information of the selected vertexes is updated based on the set material information.

A mode for updating the intermediate position information of at least some of the plurality of vertexes of the virtual object based on set material information may be: obtaining the set material information and motion states of the at least some of the plurality of vertexes of the virtual object; and performing set material calculation on the at least some of the vertexes of the virtual object according to the intermediate position information of the at least some of the vertexes, the set material information, and the motion states of the at least some of the vertexes, to obtain the target position information.

Alternatively, the target position information includes target position information of the plurality of vertexes of the virtual object. The intermediate position information of the at least some of the plurality of vertexes can be obtained by performing the set material calculation on the at least some of the vertexes. For the remaining vertexes among the plurality of vertexes, the intermediate position information of the vertexes can be directly used as the target position information of the vertexes. The set material information can be parameters that represent material properties, including air resistance, a tensile coefficient, a compression coefficient, a bending coefficient, and the like. The set material information may be set according to an actual need. The motion state of each vertex of the virtual object may be information such as a motion velocity and motion direction of the vertex of the virtual object in the current image relative to a previous image. In this embodiment, a pre-developed material calculation plug-in can be called to perform the material calculation. For example, the material calculation plug-in is used to perform set material calculation according to the material parameters, the intermediate position information of the at least some of the vertexes, and the motion states, and outputs the target position information. In this embodiment, by performing the set material calculation on the at least some of the vertexes of the virtual object according to the intermediate position information, the set material information, and the motion states, the virtual object may have the dynamic effect and texture of a set material.

Alternatively, a mode for performing set material calculation on the at least some of the vertexes of the virtual object according to the intermediate position information of the at least some of the vertexes, the set material information, and the motion states of the at least some of the vertexes may be: if a virtual object supporting body is set in a current scenario, obtaining supporting information according to the virtual object supporting entity; and performing set material calculation on the at least some of the vertexes of the virtual object according to the intermediate position information of the at least some of the vertexes, the material parameters, the motion states of the at least some of the vertexes, and the supporting information.

The virtual object supporting entity can be set according to a collision principle. Namely, it can be a collision entity, and the supporting information can be understood as collision information. In this embodiment, a region of the virtual object supporting entity is set up, and the virtual object will collide with the virtual object supporting entity, which means that the virtual object cannot pass through the virtual object supporting entity. The virtual object can be presented in a form. In this embodiment, the virtual object supporting entity can be set through the material calculation plug-in, and the material calculation plug-in obtains the supporting information according to the set virtual object supporting entity. The material calculation plug-in can be used to perform the set material calculation according to the material parameters, the supporting information, the intermediate position information of the at least some of the vertexes, and the motion states of the at least some of the vertexes, thereby obtaining the calculated target position information. In this embodiment, setting the virtual object supporting entity in the current scenario can make the virtual object be presented a form, thereby meeting the personalized need of a user. Exemplarily, FIG. 2 is a schematic diagram of a rendered virtual object in this embodiment. As shown in FIG. 2, the virtual object is a skirt. Since the set material calculation is performed on the vertexes below the waist of the skirt, the part of the skirt below the waist has the dynamic effect and texture of gauze, and a virtual object supporting entity is set below the skirt's hemline, so that the skirt's hemline has a bulging effect.
S140. The virtual object is rendered based on the target position information to obtain a target image.

The target object in the target image wears the virtual object.

In this embodiment, the plurality of vertexes of the virtual object are rendered to corresponding positions in a picture based on the target position information, thereby obtaining the target image.

A mode for rendering the virtual object based on the target position information to obtain a target image may be: sampling preset color information from a color noise image based on mapping coordinates of each vertex of the virtual object; offsetting the preset color information according to time information of the current image to obtain offset preset color information corresponding to the vertex; adjusting an initial color of the vertex of the virtual object according to the offset preset color information corresponding to the vertex and the target position information to obtain a target color of the vertex; and rendering the virtual object based on the target position information and the target color of the vertex to obtain the target image.

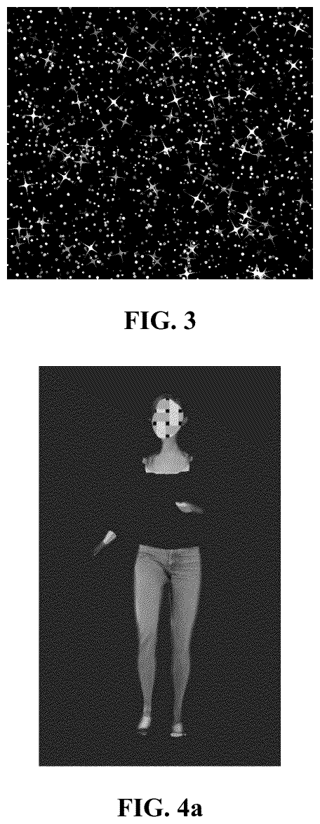

The mapping coordinates of the plurality of vertexes can be coordinates of the plurality of vertexes in a surface map of the virtual object. The color noise image may be a randomly generated noise image. Exemplarily, FIG. 3 is an example graph of a color noise image in this embodiment. FIG. 3 is a gray scale processed noise image, and an original image is a color image. In this embodiment, the color noise image and the surface map of the virtual object have the same size. Namely, pixels points between the two images are in one-to-one correspondence to each other, so that the preset color information may be sampled from the color noise image according to the mapping coordinates.

The time information of the current image can be understood as timestamp information of the current image in the video. The color information can be characterized by values of three color channels (RGB). The process of offsetting the preset color information according to time information of the current image may be: performing linear transformation on the time information to obtain an offset value; then converting RGB information of the preset color information into a Hue, Saturation, Value (HSV) color space; respectively offsetting three components in HSV information based on the offset value to obtain the offset HSV information; and converting the HSV information back to RGB information. A mode for performing the linear transformation on the time information may be: multiplying the time information by a set value to obtain the offset value. A formula for respectively offsetting the three components in the HSV information based on the offset value can be expressed as: H1=H0, S1=S0+t/360, V1=V0+t/360*0.1, wherein S0 is an S component before offsetting; S1 is an S component after offsetting; V0 is a V component before offsetting; and V1 is a V component after offsetting.

In this embodiment, a mode for adjusting an initial color of the vertex of the virtual object according to the offset preset color information corresponding to the vertex and the target position information, to obtain a target color of the vertex may be: determining a normal direction and viewing angle direction of each vertex of the virtual object according to the target position information; determining color transformation information corresponding to the vertex according to the offset preset color information corresponding to the vertex; determining a color adjustment amount of each vertex according to the color transformation information corresponding to the vertex, the normal direction of the vertex, and viewing angle direction of the vertex; and accumulating the color adjustment amount of the vertex and the initial color of the vertex of the virtual object to obtain the target color of the vertex.

The normal direction of the vertex of the virtual object can be a normal direction of a tangent plane where the vertex of the virtual object is located, and viewing angle direction of the vertex of the virtual object can be a direction in which an optical center of a camera points to the vertex of the virtual object. The color transformation information may be characterized by a color transformation matrix. The process of determining the color transformation information corresponding to the vertex according to the offset preset color information corresponding to the vertex may be: converting the values of the three color channels of the offset preset color information corresponding to the vertex into angle information, then calculating sines and cosines of the three pieces of angle information, and finally constructing the color transformation matrix corresponding to the vertex based on the sines and cosines of the three pieces of angle information. Exemplarily, a formula for converting the values of the three color channels into the angle information can be expressed as: angle information=(RGB-a)*b*π, where a and b are set values. For example, a can be set to 0.5 and b can be set to 2. Assuming X=(R-a)*b*π, Y=(G-a)*b*π, and Z=(B-a)*b*π, the color transformation matrix can be expressed as: [sinY*cosZ, cos Y*sinZ*sinX-sinY*cosX, cosY*sinZ*sinX+sinY*cosX, sinY*cosZ, sinY*cosX+sinY*sinZ*sinX, conY*sinZ*sinX-sinX*conZ, −sinZ, cosZ*sinX, and sinZ*cosX].

The color adjustment amount can be a brightness value. In this embodiment, the process of determining the color adjustment amount of the vertex according to the color transformation information corresponding to the vertex, the normal direction of the vertex, and viewing angle direction of the vertex may be: performing dot multiplication on the color transformation matrix corresponding to the color transformation information by a vector corresponding to the normal direction and a vector corresponding to the viewing angle direction to obtain the color adjustment amount. Finally, the color adjustment amount of each vertex is accumulated with the initial color of the vertex of the virtual object to obtain the target color of the vertex. In this embodiment, the color of the vertex of the virtual object can be adjusted according to the preset color information that is offset based on the time information, the normal direction, and the viewing angle direction, which may generate a flickering effect where the virtual object dynamically changes with the movement of the target object. Exemplarily, as shown in FIG. 2, a flickering effect is presented on the “skirt”.

In this embodiment, a mode for rendering the virtual object based on the target position information to obtain a target image may be: sampling the current image according to a virtual 3D target object model and a virtual object model to obtain a target object sampling image; converting the target object sampling image into a first mask image; fusing the current image with a virtual object image based on the first mask image to obtain the target image; and rendering the target image to a current picture.

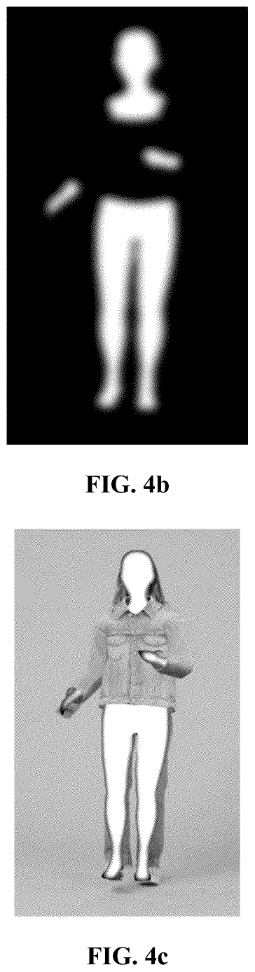

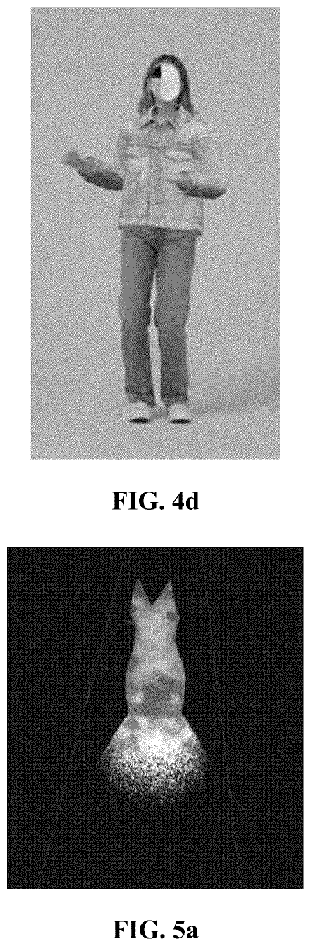

The virtual 3D target object model may be a virtual 3D model that is obtained by binding a standard target object model to a pose of the target object in the current image. The virtual object model may be understood as a 3D model corresponding to the virtual object. The process of sampling the current image according to the virtual 3D target object model and the virtual object model may be first, determining a blocking relationship between the target object and the virtual object according to the virtual 3D target object model and the virtual object model; and sampling unblocked pixel points of the target object from the current image based on the blocking relationship, thereby obtaining the target object sampling image. Exemplarily, FIG. 4a is a sample graph of a target object sampling image in this embodiment. As shown in FIG. 4a, the non-black region in FIG. 4a represents the unblocked pixel points of the target object.

A mode for converting the target object sampling image into the first mask image may be identifying the target object in the target object sampling image and obtaining the first mask image. Exemplarily, FIG. 4b is an example graph of a first mask image. As shown in FIG. 4b, the white region in FIG. 4b represents a target object region.

The virtual object image can be understood as a 2 Dimensional (2D) image obtained by projecting the virtual object onto a screen according to the target position information. Exemplarily, FIG. 4c is an example graph of a virtual object in this embodiment. As shown in FIG. 4c, the jeans wear in FIG. 4c is the virtual object.

A mode for fusing the current image with the virtual object image based on the first mask image may be: determining weighted weights according to a pixel value of a pixel point in the first mask image, and fusing the current image with the virtual object image based on the weighted weights.

Exemplarily, assuming that the pixel value of the pixel point in the first mask image is a, a is used as the weighted weight of the current image, and 1-a is used as the weighted weight of the virtual object image. A fusion formula can be expressed as: a*current image+(1-a)* virtual object image. Exemplarily, FIG. 4d is an example graph of a target image in this embodiment.

In this embodiment, the current image and the virtual object image are correspondingly fused based on the first mask image corresponding to the target object sampling image, which may accurately wear the virtual object onto the target object.

Alternatively, a mode for fusing the current image with a virtual object image based on the first mask image to obtain the target image may be performing fuzzy processing on the first mask image; and fusing the current image with the virtual object image based on the fuzzy processed first mask image to obtain the target image.

The fuzzy processing can be achieved using a fuzzy processing algorithm, which will not be limited here. A mode for fusing the current image with the virtual object image based on the fuzzy processed first mask image may be: determining weighted weights according to a pixel value of a pixel point in the fuzzy processed first mask image, and fusing the current image with the virtual object image based on the weighted weights.

Exemplarily, assuming that the pixel value of the pixel point in the fuzzy processed first mask image is b, b is used as the weighted weight of the current image, and 1-b is used as the weighted weight of the virtual object image. A fusion formula can be expressed as: vs*current image+(1-b)*virtual object image.

In this embodiment, the current image and the virtual object image are fused based on the fuzzy processed first mask image, which may achieve smooth transition between the target object and the virtual object.

A mode for rendering the virtual object based on the target position information to obtain a target image may be: obtaining a virtual 3D target object model corresponding to the target object in the current image; determining a second mask image according to a normal direction and viewing angle direction of the virtual 3D target object model; and fusing the current image with a virtual object image based on the second mask image to obtain the target image.

In this embodiment, the virtual 3D target object model is obtained by binding a standard target object model to a pose of the target object in the current image. The normal direction of the virtual 3D target object model can be understood as a normal direction of a tangent plane where 3D points in the virtual 3D target object model are located. Viewing angle direction of the virtual 3D target object model may be a direction in which an optical center of a camera points to the 3D points in the virtual 3D target object model. A mode for determining a second mask image according to a normal direction and viewing angle direction of the virtual 3D target object model may be: performing dot multiplication on the normal direction and the viewing angle direction, and using a dot multiplication result as a pixel value of a pixel point in the second mask image. A mode for fusing the current image with the virtual object image based on the second mask image may be: determining weighted weights according to the pixel value of the pixel point in the second mask image, and fusing the current image with the virtual object image based on the weighted weights. Exemplarily, assuming that the pixel value of the pixel point in the second mask image is c, c is used as the weighted weight of the current image, and 1-c is used as the weighted weight of the virtual object image. A fusion formula can be expressed as: c*current image+(1-c)*virtual object image. In this embodiment, the second mask image is determined based on the normal direction and viewing angle direction of the virtual 3D target object model to fuse the current image with the virtual object image are fused, which may improve the fusion efficiency.

Alternatively, before skeleton point position information of a target object in a current image is obtained, the method further includes the following step: The virtual object is displayed within a set duration in a set sequence in a gradual rendering manner according to the initial position information and/or the mapping coordinates of the plurality of vertexes of the virtual object.

The set sequence can be from top to bottom, from bottom to top, from left to right, or from right to left. The set duration may be any value between 1 second to 2 seconds. Gradual rendering displaying may be achieved by iterative rendering displaying or gradual rendering displaying in different regions. In this application scenario, when a user enters a clothing try-on tool and a character is detected, clothing to be tried on is displayed in a gradual displaying manner.

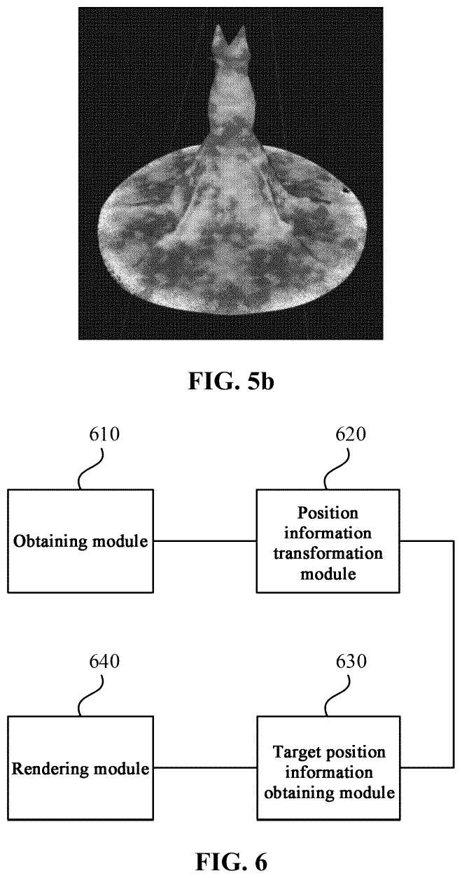

In this embodiment, a mode for displaying the virtual object within a set duration in a set sequence in a gradual rendering manner according to the initial position information and/or the mapping coordinates of the plurality of vertexes of the virtual object may be: determining vertexes of the virtual object to be displayed at each time within the set duration according to the initial position information and/or the mapping coordinates, and displaying the vertexes of the virtual object to be displayed in a picture corresponding to the time, thereby obtaining a video in which the virtual object is gradually displayed. Exemplarily, FIG. 5a to FIG. 5b are example graphs of a displayed virtual object. As shown in FIG. 5a, a portion of clothing is displayed at the time. As shown in FIG. 5b, the clothing is fully displayed. In this embodiment, the virtual object is iteratively displayed, which may enhance the display effect.

A mode for displaying the virtual object within a set duration in a set sequence in a gradual rendering manner according to the initial position information and/or the mapping coordinates of the plurality of vertexes of the virtual object may be: for current time within the set duration, determining a control parameter according to the current time; determining a target reference amount of each vertex according to the initial position information and/or the mapping coordinates of each vertex of the virtual object; determining vertexes of the virtual object to be displayed at the current time according to the target reference amount of each vertex and the control parameter; and rendering the vertexes of the virtual object to be displayed at the current time.

A mode for determining a control parameter according to the current time may be obtaining a progress of the current time within the set duration, and determining the control parameter according to the progress. Exemplarily, assuming that the set duration is T and a duration between the current time and start time is t, the progress is t/T, and the progress may be used as a control parameter The purpose of the target reference amount is to determine whether the corresponding vertexes of the virtual object is rendered. A mode for determining the target reference amount of the vertex according to the initial position information and/or the mapping coordinates of each vertex of the virtual object may be: for each of the plurality of vertexes of the virtual object, determining a first reference amount according to the initial position information of the vertex of the virtual object; sampling a gray scale value from the set noise image according to the mapping coordinates of the vertex of the virtual object, and determining the sampled gray scale value as a second reference amount; and determining the target reference amount of the vertex according to the first reference amount and/or the second reference amount.

The initial position information of the vertex of the virtual object can be understood as initial three-dimensional coordinates of the vertex making up the virtual object in the world coordinate system. Namely, the initial position information includes three coordinate components x, y, and z. The process of determining the first reference amount according to the initial position information of the vertex of the virtual object may be: first, calculating a distance between the vertex of the virtual object and an origin after the vertex of the virtual object is projected to an xz plane, then performing linear transformation on the distance, then performing index calculation on a y component, and finally accumulating a linear transformation result and an index transformation result to obtain the first reference amount. The distance between the vertex of the virtual object and the origin after the vertex of the virtual object is projected to an xz plane can be expressed as: length (xz), and the index calculation performed on the y component can be expressed as pow (y, a), which means finding the power of a of y. A calculation formula for the first reference amount can be: first reference amount=(1-b*length (xz))*c+pow (y*d, a)*e, where a, b, c, d, and e are set values. Alternatively, after the first reference amount is obtained, range restriction can be further performed on the first reference amount to ensure that the first reference amount falls within a set range, and the index calculation can be performed on the first reference amount after the range restriction. The set range can be 0 to 1.5.

The mapping coordinates may be understood as coordinates of the surface map corresponding to the virtual object. The surface map and the set noise image have the same size. Namely, the pixel points in the two images are in one-to-one correspondence. Therefore, a gray scale value corresponding to each pixel point of the surface map can be sampled from the set noise image according to the mapping coordinates, and finally, the gray scale values are used as the second reference amount. Alternatively, the second reference amount may be further multiplied by a set impact factor to obtain a final second reference amount.

Determining the target reference amount according to the first reference amount and/or the second reference amount can be understood as: using the first reference amount as the target reference amount, or using the second reference amount as the target reference amount, or using a weighted sum of the first reference amount and the second reference amount as the target reference amount. In this embodiment, the target reference amount is determined based on the initial position information and/or the mapping coordinates, which may improve the calculation accuracy.

A mode for determining the vertexes of the virtual object to be displayed at each time according to the target reference amount and the control parameter may be: If the target reference amount is less than the control parameter, the vertexes of the virtual object are not the vertexes of the virtual object to be displayed; and if the target reference amount is greater than or equal to the control parameter, the vertexes of the virtual object are the vertexes of the virtual object to be displayed.

A mode for rendering the vertexes of the virtual object to be displayed at the current time may be: determining a special effect color of the vertexes of the virtual object according to the target reference amount and the control parameter; and rendering the vertexes of the virtual object to be displayed at the current time according to the special effect color.

In this embodiment, if the target reference amount is less than the control parameter, it indicates that the vertexes of the virtual object corresponding to the target reference amount do not need to be rendered at the current time, so that the vertexes of the virtual object are ignored. If the target reference amount is greater than or equal to the control parameter, it indicates that the vertexes of the virtual object corresponding to the target reference amount need to be rendered at the current time. At this time, the special effect color corresponding to the vertexes of the virtual object needs to be determined, so as to render the virtual object at the current time according to the special effect color. In this embodiment, the vertexes of the virtual object to be rendered at the current time are determined according to a comparison result between the target reference amount and the control parameter, so that the virtual object presents a gradual display effect.

A mode for determining a special effect color of the vertexes of the virtual object according to the target reference amount and the control parameter may be: obtaining a special effect control range; performing smooth transition processing on the target reference amount based on the special effect control range and the control parameter to obtain a special effect adjustment variable; and adjusting the set color based on the special effect adjustment variable to obtain the special effect color, A

n upper limit value for special effect control and a lower limit value for special effect control. The special effect control range is set by a user and will not be limited here.

The smooth transition processing can be executed by using a set smooth transition processing function, such as the smoothstep function.

In this embodiment, the process of performing smooth transition processing on the target reference amount based on the special effect control range and the control parameter may be: firstly, performing primary smooth transition processing on the target reference amount based on the control parameter and the upper limit value for special effect control to obtain a first special effect adjustment sub-variable; then, performing secondary smooth transition processing on the target reference amount based on the control parameter, the upper limit value for special effect control, and the lower limit value for special effect control to obtain a second special effect adjustment sub-variable; and finally, accumulating the first special effect adjustment sub-variable and the second special effect adjustment sub-variable to obtain the special effect adjustment variable. Exemplarily, the first smooth transition processing can be expressed as: smoothstep (U, U+a*D1, A), and the second smooth transition processing can be expressed as: smoothstep (U-a*D2, U+a*D1, A), where U represents the control parameter; D1 represents the upper limit value for special effect control; D2 represents the lower limit value for special effect control; A represents the target reference amount; and a is a set value, for example, a is 0.1.

In this embodiment, a mode for adjusting the set color based on the special effect adjustment variable may be: multiplying the special effect adjustment variable by the set color to obtain the special effect color. In this embodiment, the smooth transition processing is performed on the target reference amount based on the special effect control range and the control parameter, which can achieve an edge lighting effect.

According to the technical solutions of the embodiments of the present disclosure, skeleton point position information of a target object in a current image and initial position information of a plurality of vertexes of a virtual object are obtained; the initial position information of the plurality of vertexes of the virtual object is transformed based on the skeleton point position information to obtain intermediate position information of the plurality of vertexes of the virtual object; the intermediate position information of at least some of the plurality of vertexes of the virtual object is updated based on set material information to obtain target position information; and the virtual object is rendered based on the target position information to obtain a target image. The target object in the target image wears the virtual object. According to the method for virtual object rendering provided in the embodiments of the present disclosure, the initial position information of the plurality of vertexes of the virtual object is transformed based on the skeleton point position information of the target object, and the intermediate position information of the at least some of the vertexes of the virtual object is updated based on the set material information, so that the virtual object that is tried on can fit well with motions of the target object, and the virtual object can have the dynamic effect and texture of a real object, which enhances the rendering effect.

FIG. 6 is a schematic structural diagram of an apparatus for virtual object rendering according to an embodiment of the present disclosure. As shown in FIG. 6, the apparatus includes: an obtaining module 610, configured to obtain skeleton point position information of a target object in a current image and initial position information of a plurality of vertexes of a virtual object, wherein the plurality of vertexes of the virtual object are a plurality of vertexes of a 3D model corresponding to the virtual object; a position information transformation module 620, configured to transform the initial position information of the plurality of vertexes based on the skeleton point position information to obtain intermediate position information of the plurality of vertexes; a target position information obtaining module 630, configured to update the intermediate position information of at least some of the plurality of vertexes of the virtual object based on set material information to obtain target position information; and a rendering module 640, configured to render the virtual object based on the target position information to obtain a target image, wherein the target object in the target image wears the virtual object.

Alternatively, the position information transformation module 620 is configured to: obtain a plurality of skeleton points associated with each vertex of the virtual object and obtain position impact weights of the plurality of skeleton points on each vertex of the virtual object; determine vertex transformation information of each vertex based on position information of the plurality of skeleton points and the position impact weights; and transform the initial position information of each vertex based on the vertex transformation information of each vertex to obtain the intermediate position information of each vertex.

Alternatively, the target position information obtaining module 630 is configured to obtain the set material information and motion states of the at least some of the plurality of vertexes of the virtual object; and perform set material calculation on the at least some of the vertexes of the virtual object according to the intermediate position information of the at least some of the vertexes, the set material information, and the motion states of the at least some of the vertexes to obtain the target position information.

Alternatively, the target position information obtaining module 630 is configured to perform set material calculation on the at least some of the vertexes of the virtual object according to the intermediate position information of the at least some of the vertexes, the set material information, and the motion states of the at least some of the vertexes in the following way: if a virtual object supporting entity is set in a current scenario, obtaining supporting information according to the virtual object supporting entity; and performing set material calculation on the at least some of the vertexes of the virtual object according to the intermediate position information of the at least some of the vertexes, material parameters, the motion states of the at least some of the vertexes, and the supporting information.

Alternatively, the rendering module 640 is configured to: sample preset color information from a color noise image based on mapping coordinates of each vertex of the virtual object; offset the preset color information according to time information of the current image to obtain offset preset color information corresponding to each vertex; adjust an initial color of each vertex of the virtual object according to the offset preset color information corresponding to each vertex and the target position information to obtain a target color of each vertex; and
render the virtual object based on the target position information and the target color of each vertex to obtain the target image.

Alternatively, the rendering module 640 is configured to adjust an initial color of each vertex of the virtual object according to the offset preset color information corresponding to each vertex and the target position information to obtain a target color of each vertex in the following way: determining a normal direction and viewing angle direction of each vertex of the virtual object according to the target position information; determining color transformation information corresponding to each vertex according to the offset preset color information corresponding to each vertex; determining a color adjustment amount of each vertex according to the color transformation information corresponding to each vertex, the normal direction of each vertex, and the viewing angle direction of each vertex; and accumulating the color adjustment amount of each vertex and the initial color of the vertex of the virtual object to obtain the target color of each vertex.

Alternatively, the rendering module 640 is configured to: sample the current image according to a virtual 3D target object model and a virtual object model to obtain a target object sampling image; convert the target object sampling image into a first mask image; fuse the current image with a virtual object image based on the first mask image to obtain the target image; and render the target image to a current picture.

Alternatively, the rendering module 640 is configured to fuse the current image with a virtual object image based on the first mask image to obtain the target image in the following way: performing fuzzy processing on the first mask image; and fusing the current image with the virtual object image based on the fuzzy processed first mask image to obtain the target image.

Alternatively, the rendering module 640 is configured to obtain a virtual 3D target object model corresponding to the target object in the current image; determine a second mask image according to a normal direction and viewing angle direction of the virtual 3D target object model; and fuse the current image with a virtual object image based on the second mask image to obtain the target image.

Alternatively, the apparatus further includes: a virtual object display module, configured to: display the virtual object within a set duration in a set sequence in a gradual rendering manner according to the initial position information and/or the mapping coordinates of the plurality of vertexes of the virtual object.

Alternatively, the virtual object display module is configured to: for current time within the set duration, determine a control parameter according to the current time; determine a target reference amount of each vertex according to the initial position information and/or the mapping coordinates of each vertex of the virtual object; determine vertexes of the virtual object to be displayed at the current time according to the target reference amount of each vertex and the control parameter; and render the vertexes of the virtual object to be displayed at the current time.

The apparatus for virtual object rendering provided in this embodiment of the present disclosure can implement the method for virtual object rendering provided in any embodiment of the present disclosure, and includes corresponding functional modules for implementing the method and corresponding effects.

The multiple units and modules included in the above apparatus are only divided according to a functional logic, but are not limited to the above division, as long as the corresponding functions can be achieved. In addition, the names of the multiple units and modules are only for the purpose of distinguishing and are not used to limit the protection scope of the embodiments of the present disclosure.

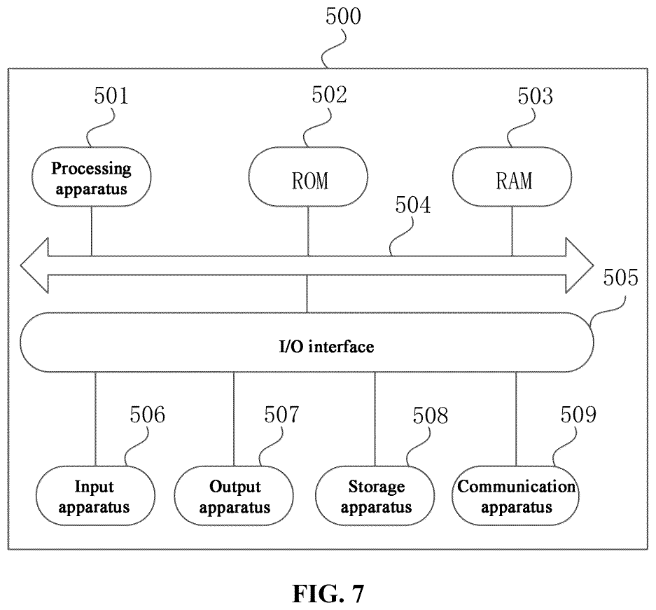

FIG. 7 is a schematic structural diagram of an electronic device according to the embodiments of the present disclosure. Reference is now made to FIG. 7 below, which illustrates a schematic structural diagram of an electronic device (namely, a terminal device or a server in FIG. 7) 500 suitable for implementing an embodiment of the present disclosure. The terminal device in the embodiments of the present disclosure may include, but not limited to, a mobile phone, a laptop, a digital broadcast receiver, a Personal Digital Assistant (PDA), a Portable Android Device (PAD), a Portable Media Player (PMP), a mobile terminal such as a vehicle-mounted terminal (for example, a vehicle-mounted navigation terminal), and a fixed terminal such as digital television (TV) and a desktop computer. The electronic device shown in FIG. 7 is only an example and should not impose any limitations on the functionality and scope of use of the embodiments of the present disclosure.

As shown in FIG. 7, the electronic device 500 may include a processing apparatus (such as a central processing unit and graphics processor) 501 that can perform various appropriate actions and processing according to programs stored in a Read-Only Memory (ROM) 502 or loaded from a storage apparatus 508 to a Random Access Memory (RAM) 503. Various programs and data required for operations of the electronic device 500 may also be stored in the RAM 503. The processing apparatus 501, the ROM 502, and the RAM 503 are connected to each other through a bus 504. An Input/Output (I/O) interface 505 is connected to the bus 504 too.

Usually, following apparatuses can be connected to the I/O interface 505: an input apparatus 506 including a touch screen, a touchpad, a keyboard, a mouse, a camera, a microphone, an accelerometer, a gyroscope, and the like; an output apparatus 507 including a Liquid Crystal Display (LCD), a speaker, a vibrator, and the like; a memory 508 including a magnetic tape, a hard disk drive, and the like; and a communication apparatus 509. The communication apparatus 509 can allow the electronic device 500 to wirelessly or wiredly communicate with other devices to exchange data. Although FIG. 7 shows the electronic device 500 with multiple apparatuses, it should be understood that the electronic device 500 is not required to implement or have all the apparatuses shown, and can alternatively implement or have more or fewer apparatuses.

According to the embodiments of the present disclosure, the process described in the reference flowchart above can be implemented as a computer software program. For example, the embodiments of the present disclosure include a computer program product, including a computer program carried on a non-transitory computer-readable medium, and the computer program includes program codes used for performing the methods shown in the flowcharts. In such an embodiment, the computer program may be downloaded and installed from a network through the communication apparatus 509, or installed from the memory 508, or installed from the ROM 502. When the computer program is executed by the processing apparatus 501, the above-mentioned functions defined in the methods of the embodiments of the present disclosure are executed.

Messages or names of information interacted between a plurality of apparatuses in the implementations of the present disclosure are only for illustrative purposes and are not intended to limit the messages or the scope of the information.

The electronic device provided in this embodiment of the present disclosure and the method for virtual object rendering provided in the above embodiment belong to the same inventive concept. Technical details not fully described in this embodiment can be found in the above embodiments, and this embodiment has the same effects as the above embodiments.

The embodiments of the present disclosure provide a computer storage medium having a computer program stored thereon. Running of the program by a processor implements the method for virtual object rendering provided in the above embodiment.

The computer-readable medium mentioned in the present disclosure can be a computer-readable signal medium, a computer-readable storage medium, or any combination of the computer-readable signal medium and the computer-readable storage medium. The computer-readable storage medium can be, for example, but not limited to, electric, magnetic, optical, electromagnetic, infrared, or semiconductor systems, apparatuses, or devices, or any combination of the above. More specific examples of the computer-readable storage medium may include but are not limited to: an electrical connection with one or more wires, a portable computer disk, a hard disk drive, a RAM, a ROM, an Erasable Programmable Read Only Memory (EPROM) or flash memory, an optical fiber, a Compact Disc Read-Only Memory (CD-ROM), an optical storage device, a magnetic storage device or any suitable combination of the above. In the present disclosure, the computer-readable storage medium may be any tangible medium that contains or stores a program, and the program can be used by or in combination with an instruction execution system, apparatus, or device. In the present disclosure, the computer-readable signal media may include data signals propagated in a baseband or as part of a carrier wave, which carries computer-readable program codes. The propagated data signals can be in various forms, including but not limited to: electromagnetic signals, optical signals, or any suitable combination of the above. The computer-readable signal medium may also be any computer-readable medium other than a computer-readable storage medium. The computer-readable signal medium can send, propagate, or transmit programs for use by or in combination with an instruction execution system, apparatus, or device. The program codes contained in the computer-readable medium can be transmitted using any suitable medium, including but not limited to: a wire, an optical cable, a Radio Frequency (RF), and the like, or any suitable combination of the above.

In some implementations, clients and servers can communicate using any currently known or future developed network protocol such as a HyperText Transfer Protocol (HTTP), and can intercommunicate and be interconnected with digital data in any form or medium (for example, a communication network). Examples of the communication network include a Local Area Network (LAN), a Wide Area Network (WAN), an internet (such as an Internet), a point-to-point network (such as an ad hoc point-to-point network, and any currently known or future developed network.

The computer-readable medium may be included in the electronic device or exist alone and is not assembled into the electronic device.

The above computer-readable medium carries one or more programs. When the above one or more programs are run by the electronic device, the electronic device is caused to: obtain skeleton point position information of a target object in a current image and initial position information of a plurality of vertexes of a virtual object; transform the initial position information of the plurality of vertexes based on the skeleton point position information to obtain intermediate position information of the plurality of vertexes; update the intermediate position information of at least some of the plurality of vertexes of the virtual object based on set material information to obtain target position information; and render the virtual object based on the target position information to obtain a target image. The target object in the target image wears the virtual object.

Computer program codes for performing the operations of the present disclosure may be written in one or more programming languages or a combination thereof. The above programming languages include but are not limited to an object-oriented programming language such as Java, Smalltalk, and C++, and conventional procedural programming languages such as “C” language or similar programming languages. The program codes may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including (a LAN or a WAN, or can be connected to an external computer (for example, through an Internet using an Internet service provider).

The flowcharts and block diagrams in the accompanying drawings illustrate possible system architectures, functions, and operations that may be implemented by a system, a method, and a computer program product according to various embodiments of the present disclosure. In this regard, each block in a flowchart or a block diagram may represent a module, a program, or a part of a code. The module, the program, or the part of the code includes one or more executable instructions used for implementing specified logic functions. In some implementations used as substitutes, functions annotated in blocks may alternatively occur in a sequence different from that annotated in an accompanying drawing. For example, actually two blocks shown in succession may be performed basically in parallel, and sometimes the two blocks may be performed in a reverse sequence. This is determined by a related function. It is also noted that each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The units and modules described in the embodiments of the present disclosure can be implemented through software or hardware. The names of a unit and a module do not constitute a limitation on the unit. For example, an obtaining module may be further described as “a module for obtaining skeleton point position information of a target object in a current image and initial position information of a plurality of vertexes of a virtual object”.

The functions described herein above may be performed, at least in part, by one or a plurality of hardware logic components. For example, non-restrictively, example hardware logic components that can be used include: a Field Programmable Gate Array (FPGA), an Application Specific Integrated Circuit (ASIC), Application Specific Standard Parts (ASSP), a System on Chip (SOC), a Complex Programmable Logic Device (CPLD), and the like.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include an electrical connection based on one or more wires, a portable computer disk, a hard disk drive, a RAM, a ROM, an EPROM or flash memory, an optical fiber, a portable CD-ROM, an optical storage device, a magnetic storage device, or any suitable combinations of the above content.

Although multiple operations are depicted in a specific order, this should not be understood as requiring these operations to be executed in the specific order shown or in a sequential order. In certain environments, multitasking and parallel processing may be advantageous. Similarly, although specific implementation details are included in the above discussion, these should not be interpreted as limiting the scope of the present disclosure. Some features described in the context of individual embodiments can also be combined and implemented in a single embodiment. Various features that are described in the context of the single embodiment may also be implemented in a plurality of embodiments separately or in any suitable sub-combinations.

Although the subject matter has been described in a language specific to structural features and/or method logical actions, it should be understood that the subject matter limited in the attached claims may not necessarily be limited to the specific features or actions described above. The specific features and actions described above are only exemplary forms for implementing the claims.

1. A method for virtual object rendering, comprising:
obtaining skeleton point position information of a target object in a current image and initial position information of a plurality of vertexes of a virtual object, wherein the plurality of vertexes of the virtual object are a plurality of vertexes of a 3 Dimensional (3D) model corresponding to the virtual object;
transforming the initial position information of the plurality of vertexes based on the skeleton point position information to obtain intermediate position information of the plurality of vertexes;
updating the intermediate position information of at least some of the plurality of vertexes of the virtual object based on set material information to obtain target position information; and
rendering the virtual object based on the target position information to obtain a target image, wherein the target object in the target image wears the virtual object.

2. The method according to claim 1, wherein transforming the initial position information of the plurality of vertexes based on the skeleton point position information to obtain intermediate position information of the plurality of vertexes comprises:
obtaining a plurality of skeleton points associated with each vertex of the virtual object and obtaining position impact weights of the plurality of skeleton points on each vertex of the virtual object;
determining vertex transformation information of each vertex based on position information of the plurality of skeleton points and the position impact weights; and
transforming the initial position information of each vertex based on the vertex transformation information of each vertex to obtain the intermediate position information of each vertex.

3. The method according to claim 1, wherein updating the intermediate position information of at least some of the plurality of vertexes of the virtual object based on set material information to obtain target position information comprises:
obtaining the set material information and motion states of the at least some of the plurality of vertexes of the virtual object; and
performing set material calculation on the at least some of the vertexes of the virtual object according to the intermediate position information of the at least some of the vertexes, the set material information, and the motion states of the at least some of the vertexes, to obtain the target position information.

4. The method according to claim 3, wherein performing set material calculation on the at least some of the vertexes of the virtual object according to the intermediate position information of the at least some of the vertexes, the set material information, and the motion states of the at least some of the vertexes comprises:
in responding to a virtual object supporting entity being set in a current scenario, obtaining supporting information according to the virtual object supporting entity; and
performing the set material calculation on the at least some of the vertexes of the virtual object according to the intermediate position information of the at least some of the vertexes, material parameters, the motion states of the at least some of the vertexes, and the supporting information.

5. The method according to claim 1, wherein rendering the virtual object based on the target position information to obtain a target image comprises:
sampling preset color information from a color noise image based on a mapping coordinate of each vertex of the virtual object;
offsetting the preset color information according to time information of the current image to obtain offset preset color information corresponding to each vertex;
adjusting an initial color of each vertex of the virtual object according to the offset preset color information corresponding to each vertex and the target position information to obtain a target color of each vertex; and
rendering the virtual object based on the target position information and the target color of each vertex to obtain the target image.

6. The method according to claim 5, wherein adjusting an initial color of each vertex of the virtual object according to the offset preset color information corresponding to each vertex and the target position information to obtain a target color of each vertex comprises:
determining a normal direction and viewing angle direction of each vertex of the virtual object according to the target position information;
determining color transformation information corresponding to each vertex according to the offset preset color information corresponding to each vertex;
determining a color adjustment amount of each vertex according to the color transformation information corresponding to each vertex, the normal direction of each vertex, and the viewing angle direction of each vertex; and
accumulating amount of the color adjustment of each vertex and the initial color of each vertex to obtain the target color of each vertex.

7. The method according to claim 1, wherein rendering the virtual object based on the target position information to obtain a target image comprises:
sampling the current image according to a virtual 3D target object model and a virtual object model to obtain a target object sampling image, wherein the virtual object model is a 3D model corresponding to the virtual object;
converting the target object sampling image into a first mask image;
fusing the current image with a virtual object image based on the first mask image to obtain the target image, wherein the virtual object image is a 2 Dimensional (2D) image obtained by projecting the virtual object to a screen according to the target position information; and
rendering the target image to a current picture.

8. The method according to claim 7, wherein fusing the current image with a virtual object image based on the first mask image to obtain the target image comprises:
performing a fuzzy processing operation on the first mask image; and
fusing the current image with the virtual object image based on the fuzzy processed first mask image to obtain the target image.

9. The method according to claim 1, wherein rendering the virtual object based on the target position information to obtain a target image comprises:
obtaining a virtual 3D target object model corresponding to the target object in the current image;
determining a second mask image according to a normal direction and viewing angle direction of the virtual 3D target object model; and
fusing the current image with a virtual object image based on the second mask image to obtain the target image, wherein the virtual object image is a 2D image obtained by projecting the virtual object to a screen according to the target position information.

10. The method according to claim 1, wherein before obtaining skeleton point position information of a target object in a current image, the method further comprises:
displaying the virtual object within a set duration in a set sequence in a gradual rendering manner according to the initial position information and/or the mapping coordinates of the plurality of vertexes of the virtual object.

11. The method according to claim 10, wherein displaying the virtual object within a set duration in a set sequence in a gradual rendering manner according to the initial position information and/or the mapping coordinates of the plurality of vertexes of the virtual object comprises:
for current time within the set duration, determining a control parameter according to the current time;
determining a target reference amount of each vertex according to the initial position information and/or the mapping coordinates of each vertex of the virtual object;
determining vertexes of the virtual object to be displayed at the current time according to the target reference amount of each vertex and the control parameter; and
rendering the vertexes of the virtual object to be displayed at the current time.

12. (canceled)

13. An electronic device, comprising:
at least one processor; and
a storage apparatus, configured to storage at least one program, wherein the at least one program, when performed by the at least one processor, causes the at least one processor to:
obtain skeleton point position information of a target object in a current image and initial position information of a plurality of vertexes of a virtual object, wherein the plurality of vertexes of the virtual object are a plurality of vertexes of a 3 Dimensional (3D) model corresponding to the virtual object;
transform the initial position information of the plurality of vertexes based on the skeleton point position information to obtain intermediate position information of the plurality of vertexes;
update the intermediate position information of at least some of the plurality of vertexes of the virtual object based on set material information to obtain target position information; and
render the virtual object based on the target position information to obtain a target image, wherein the target object in the target image wears the virtual object.

14. A non-transitory storage medium comprising computer-executable instructions, wherein when executed by a computer processor, cause the computer processor to:
obtain skeleton point position information of a target object in a current image and initial position information of a plurality of vertexes of a virtual object, wherein the plurality of vertexes of the virtual object are a plurality of vertexes of a 3 Dimensional (3D) model corresponding to the virtual object;
transform the initial position information of the plurality of vertexes based on the skeleton point position information to obtain intermediate position information of the plurality of vertexes;
update the intermediate position information of at least some of the plurality of vertexes of the virtual object based on set material information to obtain target position information; and
render the virtual object based on the target position information to obtain a target image, wherein the target object in the target image wears the virtual object.

15. The device according to claim 13, wherein the at least one program causing the at least one processor to transform the initial position information of the plurality of vertexes based on the skeleton point position information to obtain intermediate position information of the plurality of vertexes comprise instructions to:
obtain a plurality of skeleton points associated with each vertex of the virtual object and obtaining position impact weights of the plurality of skeleton points on each vertex of the virtual object;
determine vertex transformation information of each vertex based on position information of the plurality of skeleton points and the position impact weights; and
transform the initial position information of each vertex based on the vertex transformation information of each vertex to obtain the intermediate position information of each vertex.

16. The device according to claim 13, wherein the at least one program causing the at least one processor to update the intermediate position information of at least some of the plurality of vertexes of the virtual object based on set material information to obtain target position information comprise instructions to:
obtain the set material information and motion states of the at least some of the plurality of vertexes of the virtual object; and
perform set material calculation on the at least some of the vertexes of the virtual object according to the intermediate position information of the at least some of the vertexes, the set material information, and the motion states of the at least some of the vertexes, to obtain the target position information.

17. The device according to claim 16, wherein the at least one program causing the at least one processor to perform set material calculation on the at least some of the vertexes of the virtual object according to the intermediate position information of the at least some of the vertexes, the set material information, and the motion states of the at least some of the vertexes comprise instructions to:
in responding to a virtual object supporting entity being set in a current scenario, obtain supporting information according to the virtual object supporting entity; and
perform the set material calculation on the at least some of the vertexes of the virtual object according to the intermediate position information of the at least some of the vertexes, material parameters, the motion states of the at least some of the vertexes, and the supporting information.

18. The device according to claim 13, wherein the at least one program causing the at least one processor to render the virtual object based on the target position information to obtain a target image comprise instructions to:
sample preset color information from a color noise image based on a mapping coordinate of each vertex of the virtual object;
offset the preset color information according to time information of the current image to obtain offset preset color information corresponding to each vertex;
adjust an initial color of each vertex of the virtual object according to the offset preset color information corresponding to each vertex and the target position information to obtain a target color of each vertex; and
render the virtual object based on the target position information and the target color of each vertex to obtain the target image.

19. The device according to claim 18, wherein the at least one program causing the at least one processor to adjust an initial color of each vertex of the virtual object according to the offset preset color information corresponding to each vertex and the target position information to obtain a target color of each vertex comprise instructions to:
determine a normal direction and viewing angle direction of each vertex of the virtual object according to the target position information;
determine color transformation information corresponding to each vertex according to the offset preset color information corresponding to each vertex;
determine a color adjustment amount of each vertex according to the color transformation information corresponding to each vertex, the normal direction of each vertex, and the viewing angle direction of each vertex; and
accumulate amount of the color adjustment of each vertex and the initial color of each vertex to obtain the target color of each vertex.

20. The device according to claim 13, wherein the at least one program causing the at least one processor to render the virtual object based on the target position information to obtain a target image comprise instructions to:
sample the current image according to a virtual 3D target object model and a virtual object model to obtain a target object sampling image, wherein the virtual object model is a 3D model corresponding to the virtual object;
convert the target object sampling image into a first mask image;
fuse the current image with a virtual object image based on the first mask image to obtain the target image, wherein the virtual object image is a 2 Dimensional (2D) image obtained by projecting the virtual object to a screen according to the target position information; and
render the target image to a current picture.

21. The device according to claim 20, wherein the at least one program causing the at least one processor to fuse the current image with a virtual object image based on the first mask image to obtain the target image comprise instructions to:
perform a fuzzy processing operation on the first mask image; and
fuse the current image with the virtual object image based on the fuzzy processed first mask image to obtain the target image.
